(19) United States
(12) Patent Application Publication
(10) Pub. No.: US 2024/0356753 A1
(43) Pub. Date: Oct. 24, 2024

(54) SECURE COMMUNICATIONS

(71) Applicant: STMicroelectronics International N.V., Geneva (CH)

(72) Inventors: Quentin Guellaën, Trégastel (FR); Julien Montmasson, Salon de Provence (FR); Geraud Plagne, Grenoble (FR)

(21) Appl. No.: 18/636,882

(22) Filed: Apr. 16, 2024

(30) Foreign Application Priority Data
Apr. 20, 2023 (FR) 2303959

(51) Int. Cl. H04L 9/32; H04L 9/08

(52) U.S. Cl. CPC H04L 9/3236; H04L 9/0869

(57) ABSTRACT

A process comprises transmitting, by a first device and through a first communication channel, a message comprising an identifier of the first channel, a first encrypted authentication value and at least one encrypted data value, the first authentication value being associated with the first device, receiving, by a second device, the message, decrypting, by a first circuit of the second device, the first encrypted authentication value, applying, by the first circuit of the second device, at least one non-invertible operation on the first decrypted authentication value, resulting in a verification value, comparing, by the first circuit of the second device, the verification value with the identifier of the first channel, and processing the at least one encrypted data value based on the comparison.

### CROSS-REFERENCE TO RELATED APPLICATIONS

This application claims the priority benefit of French patent application number FR2303959, filed on Apr. 20, 2023, entitled “Communication sécurisée”, which is hereby incorporated herein by reference to the maximum extent allowable by law.

### TECHNICAL FIELD

The present disclosure generally relates to communications between devices interconnected with each other, in particular to a system and process of authentication of messages received through a communication channel.

### BACKGROUND

Several coupled devices interconnected with each other, for example through a network such as the Internet of Things (IoT), are configured to exchange messages through communication channels.

Communication channels are generally secured, for example thanks to the implementation of crypted communication.

However, fraudulent messages may be sent to the network after spoofing attacks.

There is a need to increase the security of message exchanges over on a network of devices interconnected with each other.

### SUMMARY

An embodiment provides a process comprising:
the transmission, by a first device and through a first communication channel, of a message comprising an identifier of the first channel, a first encrypted authentication value and at least one encrypted data value, wherein the first authentication value is associated with the first device;
the reception, by a second device, of the message;
the decryption, by a first circuit of the second device, of the first encrypted authentication value;
the application, by the first circuit of the second device, of at least one non-invertible operation on the first decrypted authentication value, resulting in a verification value;
the comparison, by the first circuit of the second device, of the verification value with the identifier of the first channel; and
the processing of the at least one encrypted data value based on the comparison.

According to an embodiment, the processing of the encrypted data value comprises, if the verification value corresponds to the identifier of the first channel, the decryption, by the first circuit, of the encrypted data value, and providing the value of the decrypted data value to a second circuit of the second device.

According to an embodiment, the above process further comprises, before the transmission of the message by the first device:
the generation of the identifier of the first channel by a first circuit of the first device, by application of the at least one non-invertible operation to the first authentication value.

According to an embodiment, the at least one non-invertible operation comprises a hashing function.

According to an embodiment, the identifier of the first channel is the name of the first channel.

According to an embodiment, the first authentication value is generated by the first device based on a unique identifier value and/or at least one random value.

According to an embodiment, the first authentication value is generated by the first circuit of the device by application of at least one cryptographic operation to the unique identifier value and/or to the at least one random value.

According to an embodiment, the at least one cryptographic operation is a non-invertible operation.

According to an embodiment, the above process further comprises the suppression, by the first circuit of the second device, of the first encrypted or decrypted authentication value when it is determined, at the comparison stage, that the first verification value does not correspond to the identifier of the first channel.

According to an embodiment, the above process further comprises:
the transmission, by the second device and through a second communication channel, of a message comprising an identifier of the second channel, a second encrypted authentication value and at least one second encrypted data value, the second authentication value being associated to the second device;
the reception, by another device, of the message;
the decryption, by a first circuit of the other device, of the second encrypted authentication value;
the application, by the first circuit of the other device, of the at least one non-invertible operation to the second decrypted authentication value, resulting in a second verification value;
the comparison, by the first circuit of the other device, of the second verification value with the identifier of the second channel; and
the processing of the at least one second encrypted data value based on the comparison.

According to an embodiment, the identifier of the second channel is the name of the second channel.

An embodiment provides a first device configured to transmit, through a first communication channel, a message comprising an identifier of the first channel and a first encrypted authentication value, associated to the first device, and at least one encrypted data value.

An embodiment provides a system comprising the above first device and a second device configured to receive the message transmitted by the first device through the first channel, the second device comprising a first circuit configured to:
decrypt the first encrypted authentication value;
apply an operation to the first decrypted authentication value, resulting in a verification value;
compare the verification value with the identifier of the first channel; and
the processing of the at least one encrypted data value based on the comparison.

According to an embodiment, the first circuit is configured to generate the identifier by applying the at least one non-invertible operation to the first authentication value.

According to an embodiment, the second device is further configured to transmit, through a second channel, a message comprising an identifier of the second channel and a second encrypted authentication value, associated to the second device, and at least one encrypted data value, wherein the second channel is the name of the second channel.

According to an embodiment, the second device is configured to generate the identifier of the second channel by applying the at least one non-invertible operation to the second authentication value.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a block diagram that illustrates an example of a system comprising electronic devices that communicate with each other;

FIG. 2 is a block diagram that illustrates an example of a device of the system according to an embodiment of the present disclosure;

FIG. 3 is a structure of a transmitted message on a communication channel according to an embodiment of the present disclosure;

FIG. 4 illustrates steps to generate a channel name, according to an embodiment of the present disclosure; and

FIG. 5 is a flow diagram that illustrates steps of a process implemented by a device of the system at the reception of a message.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the implementation of network deployments, such as the Internet of Things, is not described in detail. Similarly, the various encryption algorithms are known by the person skilled in the art and are not described in detail.

Unless indicated otherwise, when reference is made to two coupled elements, this means a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

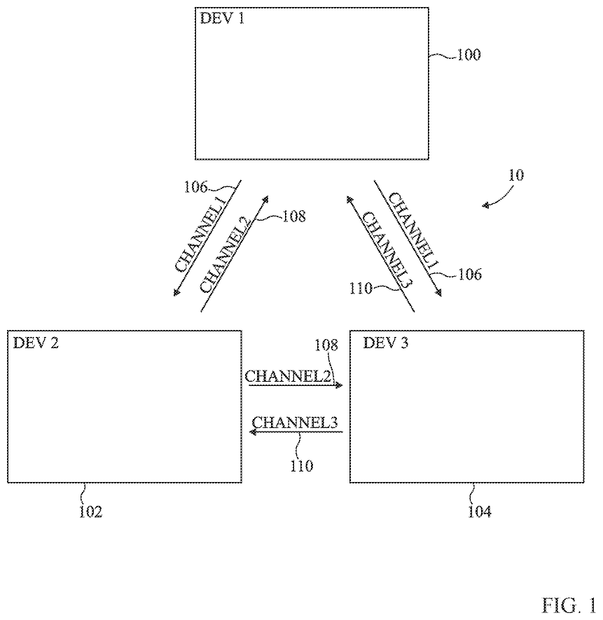

FIG. 1 is a block diagram that illustrates an example of a system 10 comprising electronic devices 100 (DEV1), 102 (DEV2) and 104 (DEV3) that communicate with each other.

For example, the devices 100, 102 and 104 are parts of a fleet of IoT. The devices 100, 102 and 104 communicate for example with each other by exchanging messages, or message flows, through dedicated communication channels.

The messages exchanged between the devices 100, 102 and 104 are, for example, configured to transmit messages comprising encrypted data. For example, the devices 100, 102 and 104 are configured to apply symmetric encryption algorithms such as, for example, AES (Advanced Standard Encryption) to one or more data values before transmitting them as a message to at least one of the other devices of the system. For example, the other devices are configured to decrypt received data. The transmitted messages comprise, for example, in addition to the encrypted data values, a preamble. A preamble of a message takes, for example, the form of a string of characters, for example under the format UTF-8 (Unicode Transformation Format-8-bit). In some cases, for example according to the norm MQTT (Message Queuing Telemetry Transport), the preamble is a topic to which one or more devices of the network can subscribe.

The messages are, for example, transmitted through communication channels. A communication channel is for example configured to transfer messages with a given preamble, the preamble therefore allowing the channels to identified in relation to each other. Then, the devices of the system 10 are configured to subscribe to at one or more communication channels to receive the messages that are transmitted through them.

When a device external to the system 10 initiates a spoofing attack, it may send fraudulent messages through one of the communication channels.

According to an embodiment, the device 100 is configured to transmit messages to other devices 102 and/or 104 through a first channel 106 (CHANNEL 1). The devices 102 and 104 are configured only to receive messages through the channel 106. In other words, the devices 102 and 104 are not configured to transmit messages through the channel 106. For example, the device 102 is configured to transmit messages to the devices 100 and 104 through a channel 108 (CHANNEL 2) and the device 104 is, for example, configured to transmit messages to the devices 100 and 102 through a channel 110 (CHANNEL 3).

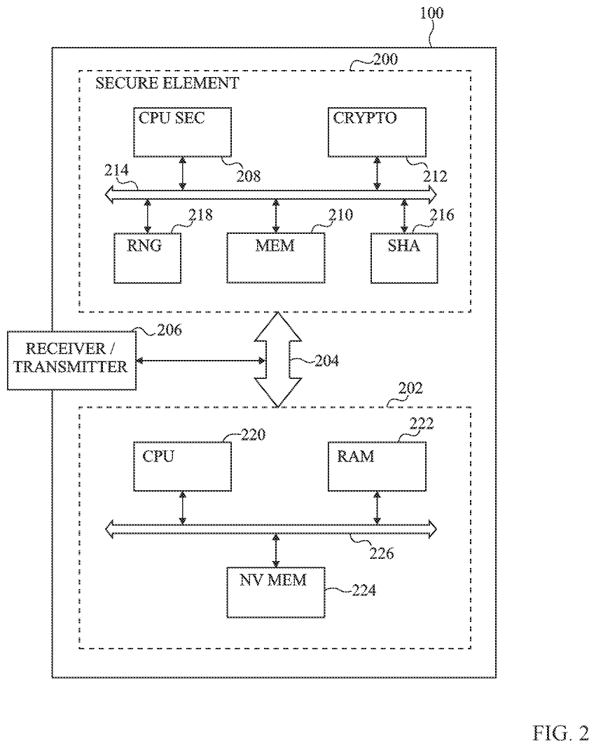

FIG. 2 is a block diagram that illustrates an example of the device 100 of the system 10 according to an embodiment of the present disclosure. Although the device 100 is pictured in FIG. 2, the devices 102 and 104 are, for example, identical to the device 100.

The device 100 comprises, for example, a secure circuit 200 (SECURE ELEMENT) coupled to a circuit 202 through a bus 204. For example, the bus 204 is a I2C bus (Inter-Integrated Circuit).

The device 100, for example, further comprises a receiver and transmitter 206 (RECEIVER/TRANSMITTER). The receiver and transmitter 206 is coupled, for example, to the bus 204. For example, the receiver and transmitter 206 comprises a radiofrequency antenna such as, for example, a Wi-Fi antenna, a 4G or 5G antenna, etc., and communication circuits configured to interface communications at the received or transmitted radiofrequencies and sent or received digital communications on the bus 204. For example, the receiver and transmitter 206 is configured to receive and emit messages on a local wireless network. In another example, the device 100 comprises an emitter circuit and a receiver circuit that are distinct from one another.

The secure circuit 200 comprises, for example, a processor 208 (CPU SEC), a memory 210 (MEM) and a cryptographic circuit 212 (CRYPTO) coupled to each other through a bus 214. As an example, the memory 210 is a non-volatile memory. As an example, the cryptographic circuit 212 is configured to encrypt and/or decrypt data according to a symmetric encryption algorithm such as, for example, an AES-type algorithm.

The circuit 200 comprises, for example, another cryptographic circuit 216 (SHA) coupled to the bus 214. For example, the circuit 216 is configured to apply at least one non-invertible operation to data values. As an example, the circuit 216 is configured to apply a hashing function, for example one of the hashing functions SHA-2 (Secure Hash Algorithm), for example SHA-256, SHA-512, SHA-224, SHA-384, SHA-512/256 or SHA-512/224. In another example, the circuit 216 is configured to apply a MD5-type hashing function (Message Digest).

The circuit 200 is further configured, for example, to generate a random value. For example, the processor 208 is configured to perform the instructions of a pseudo random number generator code. For example, instructions performing a«standard-minimal-type»algorithm are stored in the memory 210. In another example, the random value is a value of a physically unclonable function (PUF) specific to the device 100. In another example, the circuit 200 comprises a number generating circuit 218 (RNG) such as, for example, a TRNG (true random number generator).

The circuit 202 comprises, for example, a generic processor 220 (CPU), a volatile memory 222 (RAM) and a non-volatile memory 224 (NV MEM) coupled to each other via a bus 226. As an example, the volatile memory 222 is a random-access memory, and the non-volatile memory 224 is a Flash-type memory.

According to an embodiment, when the device 100 receives a message, for example through the receiver and transmitter 206, it is transmitted to the secure circuit 200.

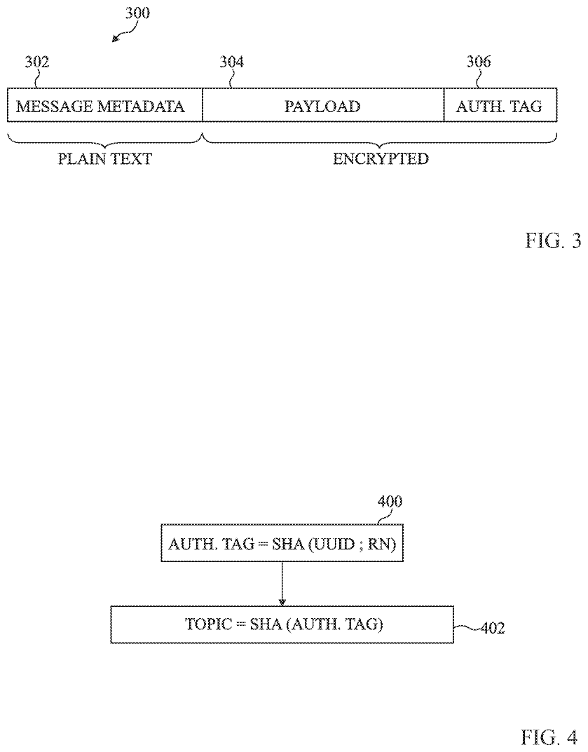

The FIG. 3 illustrates a structure of a message 300 that is transmitted on a communication channel by one of the devices of the system 10 according to an embodiment of the present disclosure.

For example, the message 300 is transmitted by the device 100, 102 or 104, respectively through the communication channel 106, 108 or 110.

The message 300 comprises, for example, a non-encrypted (PLAIN TEXT) part 302 (MESSAGE METADATA). For example, the part 302 comprises the preamble or name of the channel, where the message 300 is transmitted. For example, the part 302 is a«topic»such as a MQTT topic. The message 300 further comprises an encrypted (ENCRYPTED part 304 (PAYLOAD). For example, the part 304 comprises encrypted data corresponding to the at least one piece of data that are transmitted by the transmitter.

According to an embodiment, the message 300 further comprises an encrypted part 306 (AUTH. TAG). For example, the part 306 comprises an authentication value of the emitter.

FIG. 4 illustrates steps to generate a preamble or channel name according to an embodiment of the present disclosure.

For example, each device 100, 102 and 104 of the system 10 is associated to a unique identification value (UUID-«Universally Unique Identifier»). For example, the value specific to each device 100, 102, 104 is stored in the memory 210 of the corresponding device. For example, for each device, the associated unique identification value is generated and stored in the memory 210 during the manufacture of the device. For example, each unique identification value is coded on at least 128 bits and is generated based on characteristics proper to the associated device such as, for example, a serial number, an address such as a message authentication code (MAC), etc. Thus, two devices of the system 10 have two associated distinct values as unique identification values.

Each device of the system 10, in particular each secure circuit 200, is configured to generate its authentication value by applying, for example through the circuit 216, one or more non-invertible operations to the unique identification value. For example, the authentication value is further generated based on a random number, for example generated by a number generating circuit 218, or by the processor 202, by application of a pseudo random number generator algorithm. In another example, the authentication value is generated based on a PUF value.

Since the operations applied to the unique identification value, or to the unique identification value and to the random value and/or to the PUF value are non-invertible operations, it is not possible to retrieve the unique identification value from the authentication value.

For example, the authentication value is generated by a step 400 (AUTH. TAG=SHA (UUID,RN)). The step 400 happens, for example, prior to the emission by the device of a message flow. For example, periodically, or between two emissions of message flows, a new random value is generated and the authentication value is recalculated. For example, the authentication value is stored in the memory 210. In another example, the authentication value is temporarily stored in a volatile memory of the circuit 200.

The device is further configured, in a step 402 (TOPIC=SHA (AUTH. TAG)), to generate a preamble or a channel name based on the authentication value as calculated for the step 400. For example, the cryptographic circuit 212 of the device is configured to generate the preamble by applying a non-invertible operation to the authentication value. As an example, the used non-invertible function is a hashing function, such as SHA256. For example, the preamble is generated prior to a message flow and following the generation of the authentication value. For example, during the emission of a message flow, the generated preamble is specified in the part 300 of each message. Since the preamble results from the application of a non-invertible operation to the authentication value, it cannot be retrieved from the preamble.

The preamble generated this way is unique and depends on the device that generated it. Thus, a device of the system 10 generates a communication channel, whose name or«topic»is the generated preamble. The other devices of the system cannot generate the same preamble. Messages can be sent and transmitted by other devices of the system, but these messages will be ignored, for example, by the receiver devices. Thus, each communication channel is associated with a unique transmitter device.

The authentication value is transmitted as well, but encrypted, in the messages of the message flow. For example, the authentication value is specified in the part 304 of each transmitted message.

The non-invertible operations in the steps 400 and 402 are, for example, the same for each device of the system 10.

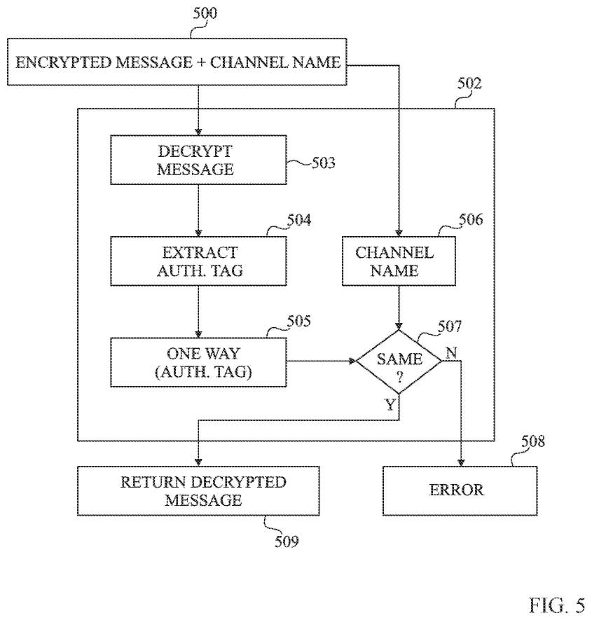

FIG. 5 is a flow diagram that illustrates operations of an implementation process by a device of the system 10 at the reception of a message from another device of the system 10 and through a communication channel. For example, the transmitter device is the device 100 and the receiver device is the device 102 and/or 104. The at least one message are then transmitted by the device 100 through the communication channel 106. The flow diagram in relationship with FIG. 5 apply to each reception of message by a receiver device of the system 10, no matter which transmitter device.

In a step 500 (ENCRYPTED MESSAGE+CHANNEL NAME), the device 100 emits a message through the channel 106. The channel 106 is defined by the«topic»or preamble generated by the device 100 in an implementation of the process described in relationship with FIG. 4. The transmitted message has, for example, the structure described in relationship with FIG. 3. In particular, the message comprises the unencrypted preamble generated by the circuit 216 during the implementation of the step 402. The message further comprises data values encrypted, for example by the cryptographic circuit 212. The message further comprises the encrypted authentication value. The authentication value is generated, for example, by the cryptographic circuit 216 of the device 100 during an implementation of the step 400, then is encrypted, for example by the cryptographic circuit 212.

For example, the receiver device receives and treats the message during a step 502. The step 502 comprises, for example, steps 503 to 507. For example, the message is received through the receiver and transmitter 206. The message is then transmitted to the secure circuit 200.

The message is sent to the cryptographic circuit 212 at the step 503 (DECRYPT MESSAGE). The circuit 212 is then configured to decrypt the encrypted part of the message, corresponding to the parts 302 and 304 of the message 300. The encrypted part comprises, for example, the encrypted data values and authentication value. In another example, the data values are not decrypted at the implementation of the step 503. For example, only the authentication value is decrypted at the step 503.

After the step 503, the process moves on to the implementation of the step 504 (EXTRACT AUTH. TAG), where the decrypted authentication value of the transmitter device is extracted from the decrypted part of the step 503. For example, the decrypted authentication value is transmitted by the cryptographic circuit 212 to the cryptographic circuit 216. In the case where only the authentication value has been decrypted at the step 503, the step 504 is, for example, sending the decrypted value to the cryptographic circuit 216.

After the step 504, the process moves on to the implementation of the step 505 (ONE WAY (AUTH. TAG)), where the non-invertible operation by the device 100 at the step 402 is applied to the decrypted authentication value. For example, the step 505 is performed by the cryptographic circuit 216. After the step 505, the result of the application of the decrypted authentication value is, for example, transmitted to the secure processor 208.

At the step 506 (CHANNEL NAME), the preamble or«topic»is extracted from the received message. For example, the preamble is transmitted to the secure processor 208. For example, the step 506 is performed as soon as the reception of the message, for example before step 503. In another example, the step 506 is performed in parallel with the succession of steps 503 to 505. In yet another example, the step 506 is performed after step 505.

Once the steps 505 and 506 performed, the process moves on to step 507 (SAME?), where the result and the preamble are compared. For example, the step 507 is performed by the processor 208.

If the result of the non-invertible operation to the decrypted authentication value is different from the preamble (branch N), the process ends with a step 508 (ERROR). For example, at the step 508, a signal or error warning is returned, for example to the circuit 202. In another example, the step 508 consists in ignoring the message without generating an error signal. For example, at the step 508, the encrypted and/or decrypted data values of the step 503 are deleted from the circuit 200. For example, the encrypted and/or decrypted authentication value is also deleted from the circuit 200. For example, the preamble is also deleted from the circuit 200.

The step 508 happens when the preamble of the received message does not correspond with the result that could have been received by the device 100 at the implementation of the step 402, or when a wrong encrypted authentication value is transmitted through the channel 106.

If, at the step 507, it is determined that the result of the non-invertible operation applied to the decrypted authentication value corresponds to the preamble (branch Y out of block 507), the process ends with a step 509 (RETURN DECRYPTED MESSAGE). The decrypted data values without the decrypted authentication value at the step 503 are transmitted, for example, to the circuit 202. For example, the decrypted authentication value is deleted from the circuit 202. For example, the encrypted authentication value is also deleted from the circuit 200. In the example where the data values are not decrypted at the step 503, the step 507 comprises the encryption of the data values before their transmission to the circuit 202.

For example, the process described in relationship with FIG. 5 is performed at reception of each message in a message flow transmitted by a device and through a communication channel. In another example, the process is performed only for one or more messages of the flow, for example for the first message in the flow. In the case where the process ends with the implementation of the step 508, the receiver and transmitter 206 is, for example, configured to refuse or not send the other messages of the flow to the circuit 200.

An advantage of the described embodiments is that they prevent any spoofing attack. Indeed, it is not possible for a device out of the system to deduce the authentication value from the preamble of a received message. Thus, the attacking device cannot provide a right couple preamble/encrypted authentication value in its message flow.

Another advantage of the described embodiments is that the received messages are treated by a secure circuit. Thus, if a message is received from a rogue device, fraudulent data is not transmitted to the circuit 202.

Another advantage of the described embodiments is that the authentication values are handled only by the secure circuit 200. Neither for the generation of the preamble by the transmitter device nor at the implementation of the step 502 by the receiver devices is the authentication value provided to the circuit 200.

Another advantage of the described implementation modes is that each communication channel is associated with a unique transmitter device. In other words, it is not possible for two distinct devices to emit messages to the same channel.

Various embodiments and variants have been described. Those skilled in the art will understand that certain features of these embodiments can be combined and other variants will readily occur to those skilled in the art. In particular, for example, about the non-invertible operations that are used, it is possible to implement a plurality of operations, including at least one non-invertible operation, at the implementation of the steps 400, 402 and 505. Similarly, the at least one operation performed at the step 400 can differ from the at least one operation performed at the step 402. In addition, the type of the at least one value used to generate the authentication value at the step 400 may vary. Indeed, for example, it is possible to generate the authentication value only from a value from a PUF and/or from a value from a number generator, no matter material or not. In addition, the moment of the decryption of the data values by the receiver devices may vary. Indeed, their decryption can happen simultaneously as the decryption of the authentication value or only when the result of the application of the non-invertible operation corresponds to the preamble.

Finally, the practical implementation of the embodiments and variants described herein is within the capabilities of those skilled in the art based on the functional description provided hereinabove. In particular, the type of cryptographic algorithm performed by the cryptographic circuits 212 and 216 may change.

What is claimed is:

1. A method comprising:
transmitting, by a first device and through a first communication channel, a message comprising an identifier of the first channel, an encrypted first authentication value associated with the first device, and at least one encrypted data value;
receiving, by a second device, the message;
decrypting, by a first circuit of the second device, the encrypted first authentication value;
applying, by the first circuit of the second device, at least one non-invertible operation on the decrypted first authentication value, resulting in a verification value;
comparing, by the first circuit of the second device, the verification value with the identifier of the first channel; and
processing, by the first circuit of the second device, the at least one encrypted data value based on the comparing.

2. The method according to claim 1, wherein the processing of the at least one encrypted data value comprises, in response to the verification value corresponding to the identifier of the first channel:
decrypting, by the first circuit of the second device, the encrypted data value; and
providing the decrypted data value to a second circuit of the second device.

3. The method according to claim 1, further comprising, before the transmitting of the message by the first device:
generating the identifier of the first channel by a first circuit of the first device, by applying the at least one non-invertible operation to the first authentication value.

4. The method according to claim 1, wherein the at least one non-invertible operation comprises a hashing function.

5. The method according to claim 1, wherein the identifier of the first channel is a name of the first channel.

6. The method according to claim 1, further comprising generating, by the first device, the first authentication value based on a unique identifier value and/or at least one random value.

7. The method according to claim 6, wherein the generating, by a first circuit of the first device, the first authentication value by applying at least one cryptographic operation to the unique identifier value and/or to the at least one random value.

8. The method according to claim 7, wherein the at least one cryptographic operation is a second non-invertible operation.

9. The method according to claim 1, further comprising suppressing, by the first circuit of the second device, the encrypted or decrypted first authentication value in response to determining, by the comparing, that the verification value does not correspond to the identifier of the first channel.

10. The method according to claim 1, further comprising:
transmitting, by the second device and through a second communication channel, a second message comprising an identifier of the second channel, an encrypted second authentication value associated with the second device, and at least one encrypted second data value;
receiving, by another device, the second message;
decrypting, by a first circuit of the another device, the encrypted second authentication value;
applying, by the first circuit of the another device, the at least one non-invertible operation to the decrypted second authentication value, resulting in a second verification value;
comparing, by the first circuit of the another device, the second verification value with the identifier of the second channel; and
processing the at least one encrypted second data value based on the comparing.

11. The method according to claim 10, wherein the identifier of the second channel is a name of the second channel.

12. A first device comprising:
a transmitter;
a first circuit comprising:
a non-transitory memory storage comprising instructions; and
a processor in communication with the memory storage and the transmitter, wherein the processor executes the instructions to:
transmit, through a first communication channel via the transmitter, a message comprising an identifier of the first channel, an encrypted first authentication value associated with the first device, and at least one encrypted data value.

13. The first device according to claim 12, wherein the processor further executes the instructions to generate the identifier of the first channel by applying at least one non-invertible operation to the first authentication value.

14. The first device according to claim 13, wherein the at least one non-invertible operation comprises a hashing function, and wherein the identifier of the first channel is a name of the first channel.

15. The first device according to claim 13, wherein the processor further executes the instructions to generate the first authentication value based on a unique identifier value and/or at least one random value.

16. The first device according to claim 15, wherein the processor further executes the instructions to generate the first authentication value by applying at least one cryptographic operation to the unique identifier value and/or to the at least one random value.

17. A system comprising:
a first device configured to transmit, through a first communication channel, a message comprising an identifier of the first channel, an encrypted first authentication value associated with the first device, and at least one encrypted data value; and
a second device configured to receive the message transmitted by the first device through the first channel, wherein the second device comprises a first circuit configured to:
decrypt the encrypted first authentication value;
apply an operation to the decrypted first authentication value, resulting in a verification value;
compare the verification value with the identifier of the first channel; and
process the at least one encrypted data value based on the compare.

18. The system according to claim 17, wherein the first circuit of the second device is further configured to generate the identifier of the first channel by applying at least one non-invertible operation to the first authentication value.

19. The system according to claim 18, wherein the second device is further configured to transmit, through a second channel, a second message comprising an identifier of the second channel, an encrypted second authentication value associated with the second device, and at least one encrypted second data value, wherein the identifier of the second channel is a name of the second channel.

20. The system according to claim 19, wherein the second device is further configured to generate the identifier of the second channel by applying the at least one non-invertible operation to the second authentication value.
